(19) United States
(12) Patent Application Publication
(10) Pub. No.: US 2008/0120461 A1
(43) Pub. Date: May 22, 2008

(54) Method for maintaining disk array management information

(75) Inventor: Chun-Ting Chen, Hsinchu (TW)

Correspondence Address: BACON & THOMAS, PLLC, 625 SLATERS LANE, FOURTH FLOOR, ALEXANDRIA, VA, 22314, US

(73) Assignee: ACCUSYS. INC., HSINCHU (TW)

(21) Appl. No.: 11/602,195

(22) Filed: Nov. 21, 2006

(51) Int. Cl. G06F 12/16

(52) U.S. Cl. 711/114; 711/E12.103

(57) ABSTRACT

A method for maintaining disk array access management information specifies a specific area in a random access memory (RAM) of a computer system or a disk array controller for storing management information of a disk array. The management information area is defined as a disk in the disk array and updated synchronously with the management information of a disk in the disk array. When the disk stores data by an array, the management information of the disk array will be saved synchronously into the management information area of the RAM. If all disks are hot plugged or unplugged, the disk array controller retrieves the updated management information from the RAM of the computer system or disk array controller, and saves the management information back into all disks after the installation of disks is completed, so as to prevent the disk array controller from being unable to operate.

### BACKGROUND OF THE INVENTION

1. Field of the Invention

The present invention relates to a method for maintaining a management information area on RAM disk and disk array member disks, and storing disk array management information in the management information area. Each time when the content of disk array management information is changed, the changed part will be updated simultaneously onto the RAM disk and all disk array member disks. Also, disk array management information can be updated synchronously from RAM disk to the member disks or from member disks to the RAM disk. Such that after all member disks are removed, the RAM disk continues maintaining the management information to prevent disk array controller from fault. And such that when a disk is reinstalled, the management information is restored from the RAM disk into that installed disk to persist disk array management information after controller power loss.

2. Description of the Related Art

Disk is one of the present popular information storage devices that features an advantage of a large capacity and becomes a common necessary storage device. In recent years, the capacity, access speed and reliability of the disk are improved greatly, but the improvements still cannot meet user requirements for the security of important data, and thus finding a way to protect important data becomes a bottleneck of the development of computer systems.

To meet the requirements for protecting important data, various different measures were proposed. For instance, a redundant array of inexpensive disks (RAID) proposed by a group of researchers of U. C. Berkeley in 1987 is one of the proposals.

The foregoing disk arrays for storing and protecting important document file are divided into different levels including RAID 1, RAID 2, RAID 3, RAID 4 and RAID 5 according to different management methods, but each processing method has its drawbacks. For example, we adopt a RAID 1 logical disk for storing disk array management information. We do this by specifying a specific area on each disk as the RAID 1 member disks and define that area as management information area. Since the disk array comes with a hot plug feature, and the data in the RAID are saved continuously, therefore the management information of the RAID will be updated anytime. Referring to FIG. 1, the structure comprises a computer system 10, a microprocessor 11 and related peripherals installed in the computer system 10. The computer system 10 is electrically connected to a disk array controller 20 controlled by the microprocessor 11, and the disk array controller 20 is electrically connected to a disk array 30 for the control of storing data into the disk array 30 and reading data from the disk array 30. The disk array 30 includes a plurality of disks 31, and these disks 31 are divided into a data area 32 and a management information area 33, and these areas are provided for storing data and management information (including system configurations, RAID configurations, system log information and system event information, etc) respectively. If at least one disk 31 in the disk array 30 is connected to the disk array controller 20, then the management information in the disk array 30 will be maintained effectively to provide normal operations of the disk array, but the drawback of this method resides on that when all disks connected to the disk array are removed, the management information stored in the management information area will disappear as well, and thus it will affect the normal operation of the disk array controller 20.

### SUMMARY OF THE INVENTION

In view of the shortcomings of prior art, the inventor of the present invention based on years of experience in the related industry to conduct extensive researches and experiments, and finally developed a method for maintaining disk array access management information in accordance with the present invention.

Therefore, it is a primary objective of the present invention to provide a method for maintaining disk array management information, and the method specifies a specific area in a random access memory (RAM) of a computer system or a disk array controller for storing disk array management information, and the management information area is defined as a member disk in the RAID 1 system and updated synchronously with the management information of a disk in the disk array, such that when the disk stores data by an array, the management information of the disk array will be controlled and saved synchronously into the management information area of the RAM. If all disks are hot plugged or unplugged, the disk array controller will retrieve the updated management information from the RAM of the computer system or disk array controller and save the management information back into all disks after the installation of disks is completed, so as to prevent the disk array controller from being unable to operate.

To make it easier for our examiner to understand the objective, shape, assembly, structure, characteristics and performance of the present invention, the following embodiments accompanied with the related drawings are described in details.

### BRIEF DESCRIPTION OF THE DRAWINGS

FIG. 1 is a schematic view of a structure of the prior art;

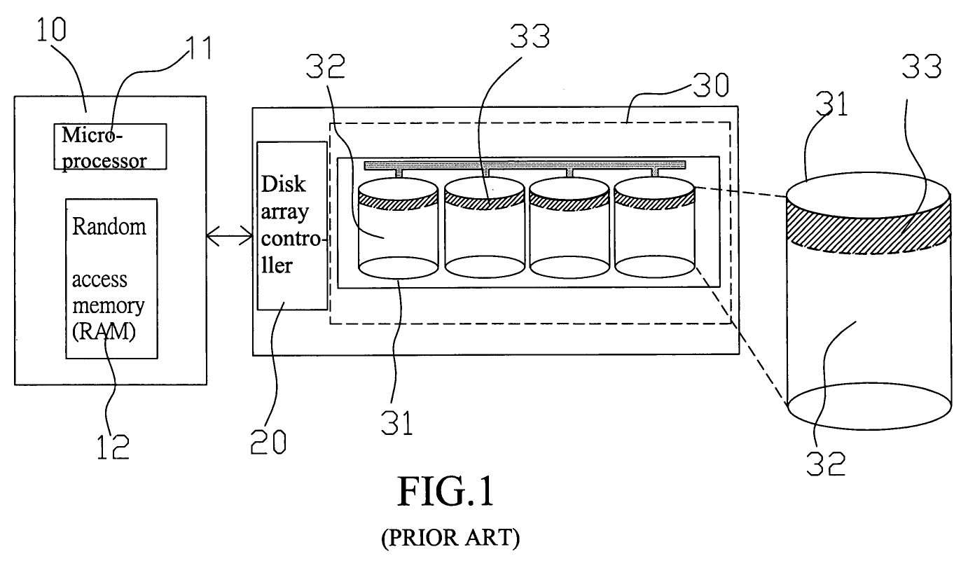

FIG. 2 is a schematic view of a structure of the present invention;

FIG. 3 is a schematic view of another preferred embodiment of the present invention; and

FIG. 4 is a flow chart of the present invention.

### DETAILED DESCRIPTION OF THE PREFERRED EMBODIMENTS

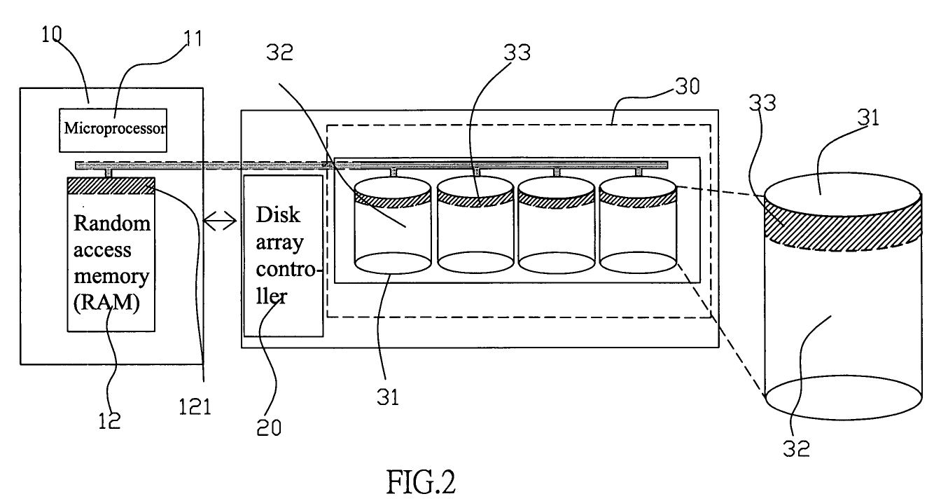

Referring to FIG. 2 for a first preferred embodiment of the present invention, the structure comprises a computer system 10, a microprocessor 11 and related peripherals installed in the computer system 10, and a random access memory (RAM) 12, and the RAM 12 adopted by this embodiment is a general RAM used for computer systems, and the present invention uses a portion of the RAM 12 as a virtual disk for storing management information. In other words, a portion of the virtual memory is defined for the use as a RAM disk. Further, the computer system 10 is electrically connected to a disk array controller 20 which is controlled by the microprocessor 11 through a bus (such as a PCI, PCI-E, or PCI-X bus) and the disk array controller of this embodiment is independently installed outside the computer system, but the persons skilled in the art can install the disk array controller in the computer system by an interface method. The disk array controller 20 is electrically connected to a disk array 30 for the control of storing data into the disk array 30 and reading data from the disk array 30. Further, the disk array 30 includes a plurality of disks 31, and these disks 31 are divided into a data area 32 and a management information area 33; wherein the data area 32 of the disk 31 is configured as a member disk of a JBOD, an N-RAID, a RAID 1, a RAID 2, a RAID 3, a RAID 4, a RAID 6, or a RAID 7 logical disk or as a RAID member disk of any type of RAID logical disk, and the RAM disk and management information area 33 on each disk configurations, RAID configuration, system log information, and system event information, etc.

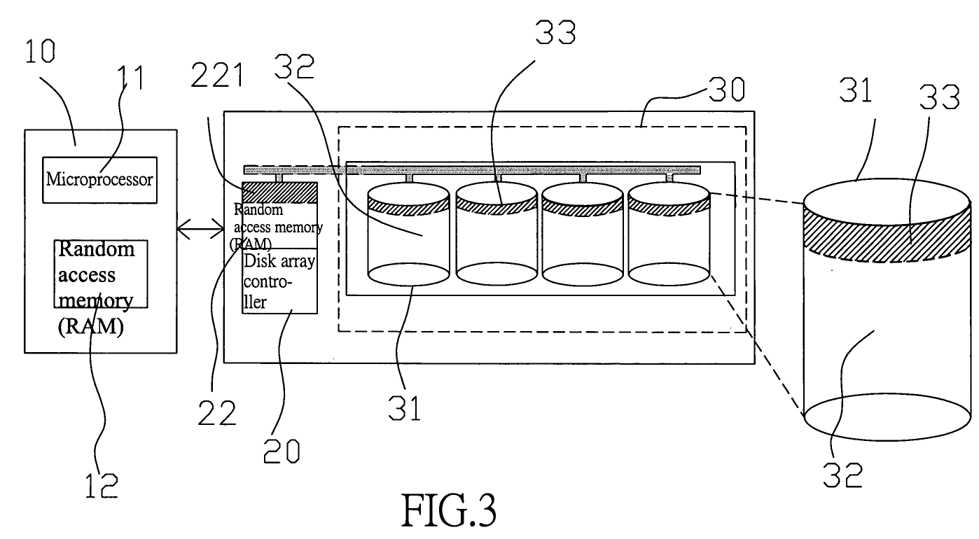

Referring to FIG. 3 for another preferred embodiment of the present invention, the difference between its structure with the first preferred embodiment resides on that the disk array controller 20 has a random access memory (RAM) 22 used as a RAM disk of a RAID 1 member disk for storing management information and connected to the disk array controller 20 and a disk array 30 for the control of storing data into the disk array 30 and reading data from the disk array 30.

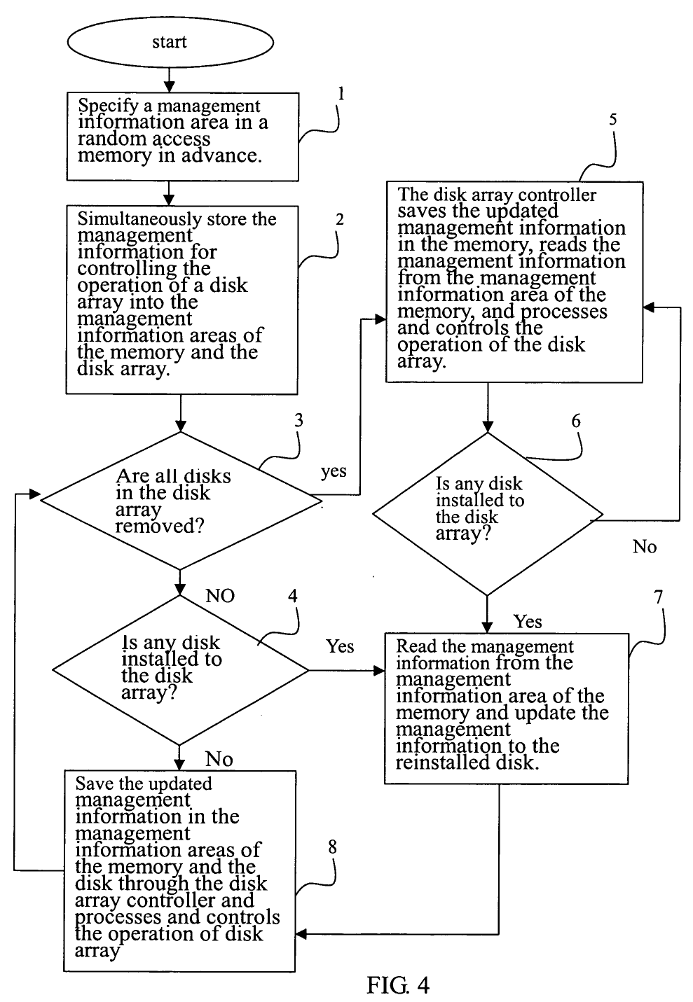

Referring to FIG. 4 for storing data in accordance with the present invention, its method comprises the following steps:

In Step 1, a management information area 121 is configured as a RAM disk in the RAM 12 and defined as a disk 33 in the disk array 30.

In Step 2, the management information is managed by a RAID 1 (Mirror Access) logical disk and synchronously updated into the management information area 121, 33 of the RAM 12 and the disk 31 of the disk array 30.

In Step 3, this step determines whether or not all disks 31 in the disk array 30 are removed; if no, then go to Step 4; and if yes, then go to Step 5.

In Step 4, this step determines whether or not the disk 31 in the disk array 30 is reinstalled; if yes, go to Step 7, or else go to Step 8.

In Step 5, the updated management information will be saved into the management information area 121 of the RAM 12 by the disk array controller 20 and the management information will be read for controlling the operation of the disk array 30, if all disks 31 in the disk array 30 are removed.

In Step 6, this step determine whether or not the disk 31 in the disk array 30 is reinstalled; if no, repeat Step 5; and if yes, go to Step 7.

In Step 7, the management information in the management information area 121 of the RAM 12 is read, and the management information is updated to the management information area 33 of the recently reinstalled disk 31 then go to Step 8.

In Step 8, the disk array controller 20 stores the updated management information into the management information areas 121, 33 of the RAM 12 and the disk 31 and process and controls the operation of the disk array.

With the control of the disk array controller 20, the operation of all disks 31 is detected. If the operation is normal, the data saving process as described in Steps 2, 3, 4 and 8 will be repeated continuously.

On the other hand, the data saving as described in Steps 5 to 8 will be processed, if all disks 31 are removed by the hot plug method.

If any disk 31 is installed incorrectly, the management information stored in the RAM 22 allows the disk array controller 20 to continue operating, and the present invention is definitely an outstanding invention.

In summation of the above description, the present invention herein provides a simple and easy structure, saves the cost, enhances the performance, overcomes the shortcomings of the prior art, and further complies with the patent application requirements, and thus the invention is duly filed for patent application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for maintaining disk array management information, comprising:
specifying a management information area for all disks in a disk array, for storing a management information for storing a disk array;
specifying a data area excluding said management information area for all disks in a disk array, for storing data;
specifying a management information area in a RAM and setting said management information area as a member in said disk array and synchronously updating said management information of said disk in said disk array;
saving said data into a corresponding data area of said disk when said disk array controller saves said data;
in the same time storing said management information in said disk and said management information area of said RAM by said disk array controller;
detecting the operation of all disks through said disk array controller; if any disk is removed by a hot plug method, said disk array controller will retrieve an updated management information from said management information area of said RAM and store said management information back to said disk when said disk is reinstalled; and if all disks in said disk array are removed by said hot plug method, said disk array controller will retrieve an updated management information from said management information area of said RAM and store said management information back to said disk when said disks are reinstalled, so as to continue the operation of said disk array controller.

2. The method for maintaining disk array management information of claim 1, wherein if said disk array controller detects the operation of all disks and all disks are operating normally, then a saving process will be continued.

3. The method for maintaining disk array management information of claim 1, wherein said RAM stores management information into a predetermined specific area.

4. The method for maintaining disk array management information of claim 1, wherein said RAM is installed to a computer system.

5. The method for maintaining disk array management information of claim 1, wherein said RAM is installed to said disk array controller.

6. The method for maintaining disk array management information of claim 1, wherein said disk array controller is installed to a computer system by an interface method.

7. The method for maintaining disk array management information of claim 1, wherein said disk array controller is installed independently outside a computer system.

8. The method for maintaining disk array management information of claim 1, wherein said disk includes a data accessible by a method selected from the collection of JBOD, N-RAID, RAID 1, RAID 2, RAID 3, RAID 4, RAID 6 and RAID 7 for accessing said data.
